(19) United States
(12) Patent Application Publication
(10) Pub. No.: US 2026/0227546 A1
(43) Pub. Date: Aug. 6, 2026

(54) METHOD FOR INTEGRATING THE FLUID DYNAMIC, THERMODYNAMIC, AND KINETIC MODELS OF THE CALCIUM CARBONATE SCALE IN THE WELL COMPLETION

(71) Applicants: PETRÓLEO BRASILEIRO S.A. - PETROBRAS, RIO DE JANEIRO (BR); UNIVERSIDADE TECNOLÓGICA FEDERAL DO PARANÁ - UTFPR, Curitiba (BR)

(72) Inventors: Umberto Sansoni JUNIOR, Rio de Janeiro (BR); Carolina Bertholdo Da CUNHA, Rio de Janeiro (BR); Andre Leibsohn MARTINS, Rio de Janeiro (BR); Silvio Luiz De Mello JUNQUEIRA, Curitiba (BR); Joao Vitor Faidiga SILVA, Curitiba (BR); Mateus Pagliarini SCHWALBERT, Rio de Janeiro (BR); Marina Elizabeth MAZUROSK, Curitiba (BR); Vinicius Gustavo POLETTO, Curitiba (BR); Helga Elisabeth Pinheiro SCHLUTER, Rio de Janeiro (BR); Ayrton Cavallini ZOTELLE, Curitiba (BR); Bruno Barbosa CASTRO, Rio de Janeiro (BR); Marcello MARQUES, Rio de Janeiro (BR); Carlos Eduardo Rambalducci DALLA, Curitiba (BR); Galileu Paulo Henke Alves De OLIVEIRA, Rio de Janeiro (BR); Thiago Machado NEUBAUER, Curitiba (BR); Plinio Martins Dias Da SILVA, Rio de Janeiro (BR); Fernando Cesar De LAI, Curitiba (BR)

(73) Assignees: PETRÓLEO BRASILEIRO S.A. - PETROBRAS, RIO DE JANEIRO (BR); UNIVERSIDADE TECNOLÓGICA FEDERAL DO PARANÁ - UTFPR, Curitiba (BR)

(21) Appl. No.: 19/457,424

(22) Filed: Jan. 23, 2026

(30) Foreign Application Priority Data
Jan. 31, 2025 (BR) 1020250020513

(51) Int. Cl. E21B 43/00; E21B 43/16; E21B 47/008; E21B 47/10; E21B 49/00; G06F 113/08

(52) U.S. Cl. CPC G01V 20/00; E21B 47/006; E21B 47/10; E21B 49/08; E21B 2200/20

(57) ABSTRACT

Integrated method for evaluating and mitigating formation of calcium carbonate scales in oil and gas well completion systems. Pertaining to the field of oil engineering, the methodology combines computational fluid dynamics (CFD), thermodynamic and kinetic models, allowing the simulation and prediction of behavior of scales under complex operating conditions. The method has five main steps: collection of geometric and operational data; generation of velocity and pressure profiles; calculation of the crystal deposition rate; thermodynamic and kinetic simulation of the precipitation and scaling processes; and calculation of a scale index that quantifies the risk associated with each piece of equipment and completion. The methodology assists in identifying critical points, optimizing designs, and reducing operational costs, ensuring greater efficiency and reliability in offshore environments. The application includes comparing different completion configurations and defining operational parameters that minimize scale formation, promoting safer, more sustainable, and economical operations.

### RELATED APPLICATION DATA

This application is based on and claims priority to Brazilian Application No. BR 10 2025 002051 3, filed on Jan. 31, 2025, the entire contents of which are incorporated herein by reference.

### FIELD OF THE INVENTION

The present invention pertains to the technical field of oil engineering, with emphasis on oil and natural gas production processes in offshore environments. More specifically, it is a methodology and tool for evaluating and mitigating calcium carbonate scales in well completion systems. The invention is applicable in the planning, design and operation of completions, providing detailed solutions adapted to the specific conditions of each well, reducing operating costs and increasing productive efficiency.

### BACKGROUND OF THE INVENTION

The evaluation scale in of oil wells traditionally uses computer programs based on phase equilibrium thermodynamics. A common example is the MultiScale software, which assesses scale potential by considering the concentration of ions in the brine (such as magnesium, calcium, barium, strontium) and the presence of dissolved carbon dioxide in the oil and water phases. Despite the validation and calibration with experimental results under high pressure and high temperature conditions, common in oil wells, the models tend to provide conservative results when applied to the productive reality, due to the exclusive focus on equilibrium conditions. Equilibrium thermodynamics assumes a process time that does not correspond to the residence time of the fluids in the production system, resulting in often overestimated precipitation predictions.

In addition to thermodynamic models, there are also kinetic models, such as ScaleSoftPitzer, which offer the ability to predict the scaled mass over time. The results provide a temporal view of scale formation, but have significant limitations, as they are only applicable to simple flows and cannot capture the complexity of flows in valves and equipment present in the industrial operations. In addition, information on the balance between the particle populations within the liquid is not detailed with regard to the size distribution of the produced solids, or to the polymorphism of the formed solid phases.

Although kinetic software provides useful information, it is limited in depth and applicability, especially compared to the proposed tool, which offers a more detailed and comprehensive analysis of the scale processes under complex industrial conditions.

In view of this, the objective of the invention is to solve the limitations of the traditional methods for scales prediction, which rely exclusively on thermodynamic phase equilibrium models or simplified kinetic models. These methods do not capture the complexity of the flows in industrial production systems, leading to conservative or imprecise predictions about scale formation. The inability to precisely identify the critical deposition points, the polymorphism of the formed solid phases, and the granulometric distribution of the solids reduces the efficiency of the operations and increases the costs associated with the interventions and maintenances.

### STATE OF THE ART

Document CN108804862A describes a method for predicting the tendency of calcium carbonate scale formation, especially useful in water samples from oil fields. The main objective is to establish a methodology that allows anticipating the probability of scaling in oil extraction and transportation systems. Firstly, the process involves collecting water samples from the oil fields for homogenization treatment, aiming to remove impurities and obtain information such as pH, ionic components and specific conditions of the system where the prediction is made, such as pipelines and wells.

Document CN115831243B describes a method for predicting the critical temperature and pressure at which scaling occurs in oil and gas wells, considering factors such as water evaporation and release of dissolved carbon dioxide, due to the pressure drop at high temperatures. The invention utilizes principles phase of equilibrium, chemical equilibrium, activity coefficient, and solubility product to construct a scale prediction model. This model allows the creation of a temperature and pressure discrimination chart critical for scale, aiding in the monitoring and prevention of problems associated with the scale buildup on the well walls.

Document US2022112799A1 describes a system comprising a set of instrumentation around the well that measures critical parameters such as temperature, pressure, and ion concentrations. This data is essential for monitoring the production conditions and for evaluating the gas-oil ratio (GOR), which indicates the proportions of gas, oil, and water in the produced fluid. The control of these parameters is done with the aid of computer equipment, which optimizes the production conditions to reduce both corrosion and scales.

However, it is evident that none of the documents of the state of the art are capable of integrating, in a multi physic and detailed manner, the aspects of fluid dynamics, thermodynamics, and chemical kinetics to evaluate and predict the formation of scales in oil and gas well completion systems. The methods described are limited to simplified or specific approaches, such as the use of treated samples for trend analysis (CN108804862A), models based only on phase equilibrium and chemistry (CN115831243B), or critical parameter monitoring systems without complete analytical integration (US2022112799A1).

The present invention overcomes these limitations by offering a robust method that combines advanced CFD simulations, kinetic and thermodynamic modeling, allowing the calculation of scale rates and the prediction of the behavior of suspended and scaled solids. In addition, the proposal presents a detailed comparative analysis by means of a scale index, something absent in the documents of the state of the art, allowing not only the prediction but also the optimization of completion design and reduction of scale risk under complex operating conditions. In this way, the invention meets a technical need not resolved by currently available methods.

### SUMMARY OF THE INVENTION

The present invention proposes an integrated method for evaluating and mitigating the formation of calcium carbonate scales in oil and gas well completion systems. Pertaining to the field of oil engineering, the method combines computational fluid dynamics (CFD), thermodynamic and kinetic models, allowing the simulation and prediction of the behavior of scales under complex operating conditions. The invention comprises five main steps: collection of geometric and operational data; generation of velocity and pressure profiles; calculation of the crystal deposition rate; thermodynamic and kinetic simulation of the precipitation and scale processes; and calculation of a scale index that quantifies the risk associated with each piece of equipment and completion.

The present invention overcomes the limitations of the traditional methods based on phase equilibrium models and simplified kinetics, offering a more detailed analysis adapted to the specific conditions of each well. The methodology assists in identifying critical points, optimizing designs and reducing operating costs, ensuring greater efficiency and reliability in offshore environments. The application includes the comparison of different completion configurations and the definition of operational parameters that minimize the scale formation, promoting safer, more sustainable and economical operations.

### BRIEF DESCRIPTION OF THE DRAWINGS

The present invention will be described below with reference to the typical embodiments thereof and also with reference to the accompanying drawings, in which:

FIG. 1 is a general flowchart of the steps of the integrated method of the present invention.

FIG. 2 is a detailed flowchart of the methodology for generating velocity and pressure magnitude profiles in the completion configuration of the present invention.

FIG. 3 is a detailed flowchart of the deposition rate calculation in each piece of equipment of the completion of the present invention.

FIG. 4 is a flowchart representing the sequence of thermodynamic calculations of the three-phase chemical equilibrium model for the calcium carbonate precipitation simulation of the present invention.

FIG. 5 is a flowchart representing the sequence of kinetic calculations of the population balance model (PBM) applied to the dispersed and scaled crystal populations of the present invention.

FIG. 6 is a graph representing the velocity and pressure profiles for the PACI 3Z completion configuration, simulated based on the CFD model, according to an exemplary embodiment of the present invention.

FIG. 7 is a graph representing the velocity and pressure profiles for the PACI 2+1 completion configuration, simulated based on the CFD model, according to an exemplary embodiment of the present invention.

### DETAILED DESCRIPTION OF THE INVENTION

The present invention relates to an integrated method that combines computational fluid dynamics (CFD), thermodynamics, and chemical kinetics to simulate and evaluate the scale formation in completion systems. The multi physic approach allows calculating the scaled mass over time and the axial length of the completion, considering the real operating conditions such as flow rates, pressure, temperature, and chemical composition of the fluids. In addition, the invention introduces the calculation of a scale index, which allows direct comparison of different completion architectures and equipment, enabling a quantitative and predictive analysis of the scale risk.

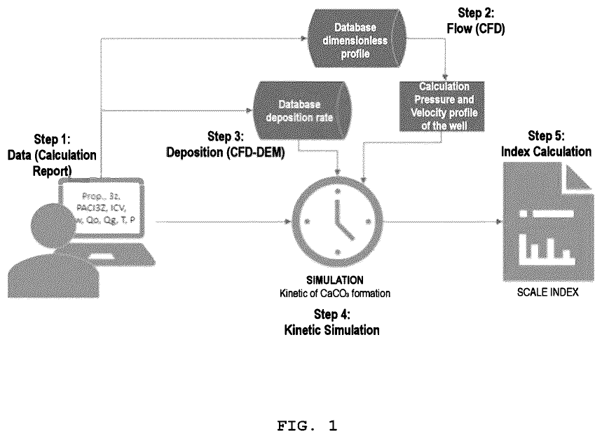

The components of the invention configure an activity flowchart, as exemplified in FIG. 1, consisting of five specific Steps. Step 1 consists of collecting the data necessary to perform the simulation. Considering that the methodology addresses to the formation of CaCO₃ in a multi physic manner, integrating fluid dynamics, liquid-solid flow, phase equilibrium thermodynamics, and chemical kinetics, the number of variables involved is large. Step 2 consists of obtaining velocity and pressure magnitude profiles for the completion. Step 3 comprises identifying the deposition rate of each piece of equipment of the completion. In Step 4, the thermodynamic equilibrium and chemical kinetics simulation is performed, obtaining the scale rates in each region of the completion. Finally, in Step 5, the scale index is calculated, used to quantitatively assess the scaling tendency of the completion.

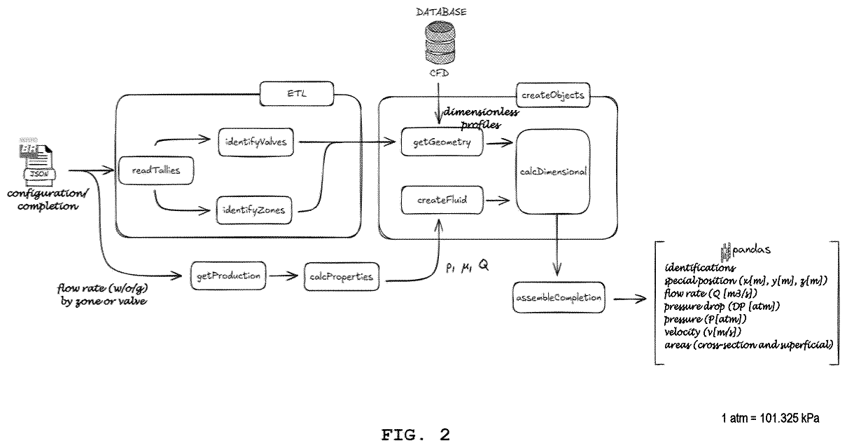

The flowchart of Step 2, shown in FIG. 2, presents the methodology for generating velocity and pressure magnitude profiles for the completion configuration. Initially, the type of completion, the number of zones, and the installed equipment are identified. In parallel, flow rate information for the phases (water, oil, and gas) is obtained to be used in the calculation of equivalent properties of a water-oil emulsion, as such viscosity and density. Subsequently, the dimensionless velocity magnitude profile and the dimensionless pressure profile are composed by concatenating characteristic profiles available in a database. The characteristic profiles have already been simulated by using CFD techniques and are available in a database. Subsequently, the dimensionless profile is properly put into dimensional form by assigning the specific production flow rate to each zone.

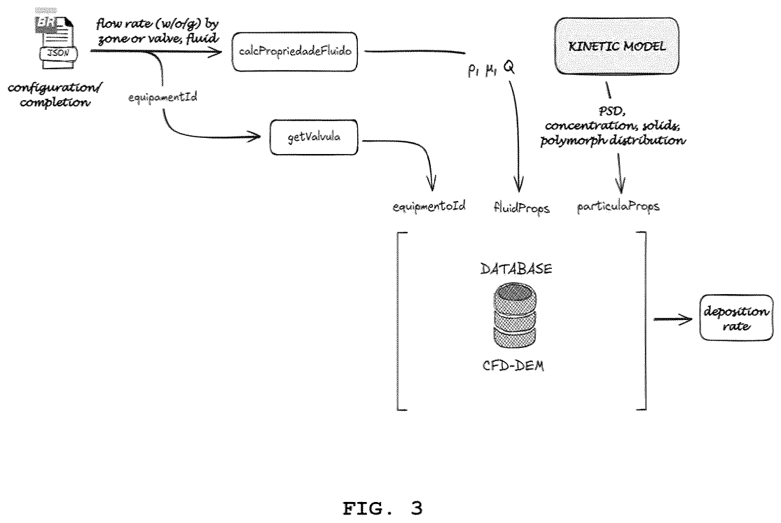

Step 3, whose flowchart is shown in FIG. 3, consists of calculating the deposition rate in each piece of equipment of the completion, aiming at the segregation of the populations between crystals precipitated within the liquid and crystals scaled on the surface. Initially, the input data correspond to the type of equipment, the flow rate, the fluid properties and the properties of the dispersed solids, obtained through the kinetic simulation, such as the granulometric distribution, the polymorph distribution and the solids concentration. Subsequently, the adhesion rate is searched in a database, looking for conditions compatible with the input data. Then, the interpolation is performed to calculate the rate under the desired condition, making such data available for subsequent Steps.

The database consists of results of characteristic deposition rates simulated through CFD-DEM. The simulation includes the transport, agglomeration and deposition of solid particles subject to adhesion forces and the action of turbulent flow.

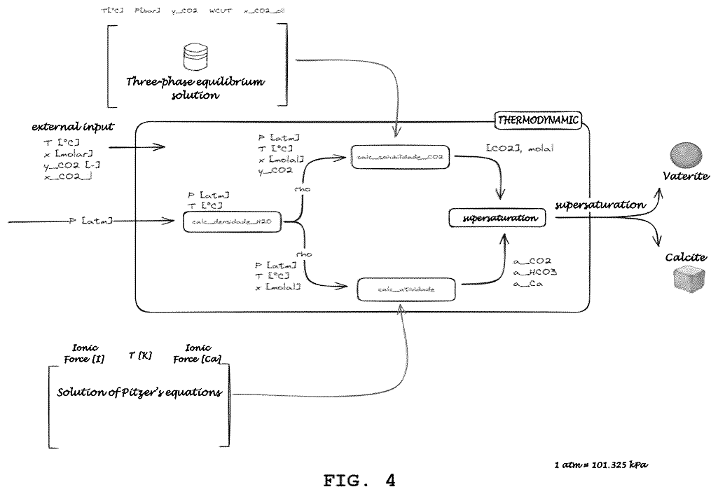

The information from Steps 1, 2, and 3 is then fed into Step 4, which comprises the simulation of the calcium carbonate (CaCO₃) precipitation process in equilibrium systems between saline waters and carbon dioxide. The input parameters are: temperature, pressure (obtained from CFD), salinity of the aqueous phase, pH value and solution volume, pressure profile, and residence time (obtained from the velocity profile). The first activity in Step 4 is the solution of the thermodynamic model. Here, by using the thermodynamic model proposed in Neubauer's approach (2022), the simulation is initiated by performing thermodynamic calculations of three-phase chemical equilibrium under the conditions of interest, to obtain the equilibrium constants of the polymorphs that exhibit stability and the expected order of their appearance. In this way, the supersaturation that each polymorph presents under the determined chemical equilibrium conditions is calculated. A flowchart representing the sequence of thermodynamic calculations for this step is shown in FIG. 4.

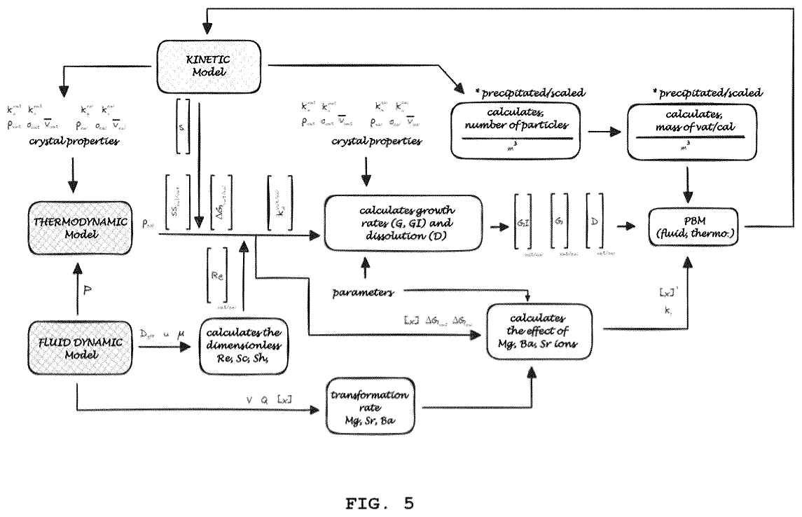

The thermodynamic calculations performed are then fed into a kinetic model responsible for calculating the rates at which these solids nucleate, grow, agglomerate, and transform over time. The proposed population balance model, PBM, is based on Neubauer's approach (2022), with the compatibility of the velocity divergent with the flow velocity profile. The population balance is modified to be applicable to a flowing system with two types of populations, flowing and scaled on the control surface, for a complete representation of the system with precipitation and scale (Eroini et al., 2013). In this context, two segregated populations are considered, one dispersed within the liquid interacting within the flow timescale, and the other scaled and static, subject to a longer residence time. The flowchart representing the sequence of kinetic calculations in this Step is presented in FIG. 5.

Finally, in Step 5, based on the kinetic results, it is possible to calculate the scale index in each piece of equipment of the completion, denoted in the equation below by the index k:

$${Index}_{( k )} = \frac{0.002}{{m}_{kineticoutlet ( k )} - {m}_{kineticinlet ( k )}}$$

The index is calculated from the difference between the mass of calcium carbonate at the inlet (m_{kineticinlet (k)}) and at the outlet of the equipment (m_{kineticoutlet(k)}) in each producing zone. From the individual indices of each piece of equipment, the completion index is computed through the weighted average by mass concentration.

In short, the method of integrating the fluid dynamic, thermodynamic and kinetic models of the calcium carbonate scale in the well completion comprises:
a) collection of geometric, operational and chemical composition data of the completion and the production fluids;
b) generation of velocity and pressure magnitude profiles throughout the completion, using computational fluid dynamics (CFD) techniques;
c) calculation of the solid crystal deposition rate in completion equipment, considering the segregation of the suspended and scaled crystal populations, based on a population balance model (PBM);
d) performance of thermodynamic and kinetic simulations, integrating the results of the previous steps to predict the nucleation, growth, and deposition processes of crystals under specific chemical equilibrium and flow dynamics conditions; and
e) calculation of a scale index for each piece of equipment and for the completion as a whole, allowing for the quantitative and comparative analysis of the scale risk.

### Exemplary Embodiments

Next, the results of a comparison between a PACI3Z type completion and a PACI2+1 type completion for a Sapinhoa well will be presented.

Step 1 of the methodology consists of obtaining the geometric and operational characteristics of the equipment that make up the completions. This information is essential for simulating velocity and pressure magnitude profiles along the well. It is crucial to know in detail the equipment used in each completion, their position, and production flow rate in each region of the system to ensure the precision of the results.

Data on the PACI 3Z completion: three producing zones, each 200 meters long, with a total flow rate of 40,000 barrels per day (bbl/d). The configuration includes three multi-position flow control valves (ICVs), one for each producing zone.

Data on the PACI 2+1 completion: three producing zones, each 200 meters long, with a flow rate of 40,000 barrels per day (bbl/d). The main difference lies in the open well configuration. In the lower and intermediate zones, 5½″ (13.97 cm) sliding sleeve valves (SSDs) are used, while in the upper zone, there is a 7⅝″ (19.3675 cm) large diameter sliding sleeve valve (SSD). The production from the upper zone is discharged into a multi-position ICV valve, which receives, in addition to the flow from the upper zone, the flow rates from the lower and intermediate zones through the production string.

In Step 2, a single velocity and pressure magnitude profile is obtained to represent the well resulting from combinations of completion equipment. The methodology consists of employing individual and specific dimensionless profiles for each piece of equipment and composing the well profile by concatenating it with typical profiles of circular (string) and annular cross-section pipes.

In this way, Equation (1) is used to dimension the velocity profile u [m/s] as a function of the valve position “x” [m], the characteristic dimensionless velocity u*(x) [-] and the productive flow fraction z [-]. The subscripts “an” and “col” indicate application to the annular and string regions, respectively. The characteristic dimensional pressure profile, P [bar] (1 bar=100 kPa) is obtained analogously by Equation (2).

$$u ( x , z , Q ) = [ {u}_{\text{?}}^{\text{?}} ( x ) {z}_{\text{?}} + \text{?} ( x ) {z}_{\text{?}} ] {Q}_{\text{?}} \qquad ( 1 )$$

$$P ( x , Z , Q , ρ ) = [ {P}_{\text{?}}^{\text{?}} ( x ) {Z}_{\text{?}} + {P}_{\text{?}}^{\text{?}} ( x ) {Z}_{\text{?}} ] ρ {Q}_{\text{?}}^{\text{?}} \qquad ( 2 )$$

$$\text{?} \text{indicates text missing or illegible when filed}$$

Table 1 shows how the operator z is applied to each zone, denoted by the equipment position x, in order to compute the mixing ratio of the production of the zone in question with that of downstream zones. The characteristic profiles P* and u* are obtained through computational fluid dynamics simulations using the Finite Volume Method to solve the single-phase turbulent flow.

TABLE 1
Flow fractions for each producing zone.

| | Annular | String |
|---|---|---|
| Upper | Zsup | Zinf + Zint |
| Intermediate | Zint | Zinf |
| Lower | Zinf | 0 |

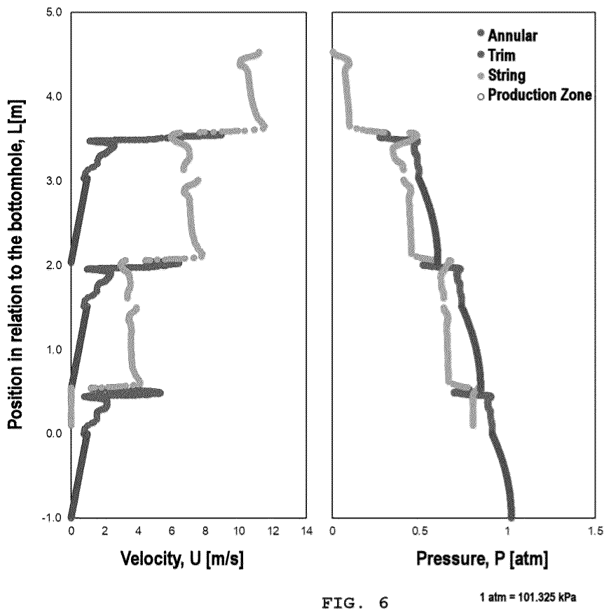

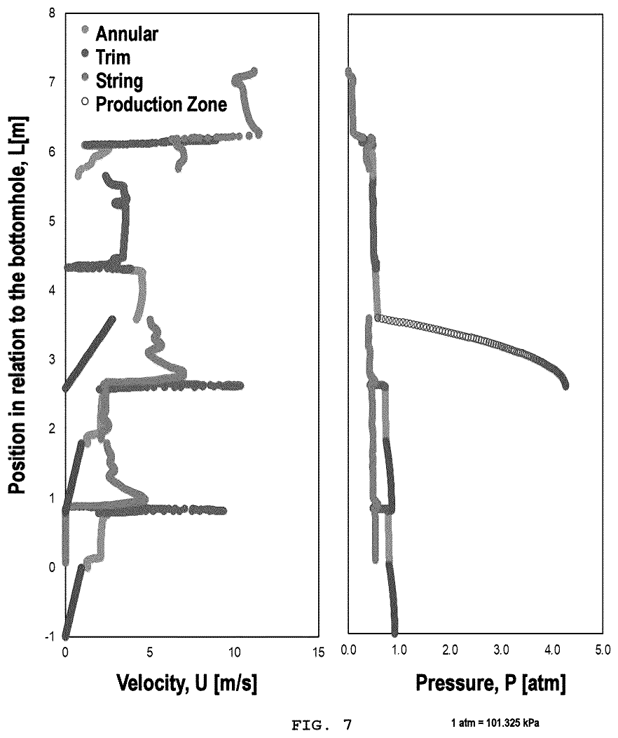

Based on the construction parameters and operating conditions of the completions, it is possible to simulate the velocity and pressure profiles by using the CFD model. These profiles are essential to understand the flow behavior within the producing zones and along the production string, and are presented in FIG. 6 and FIG. 7 for the PACI 3Z and PACI 2+1 completions, respectively.

For the PACI 3Z, it is observed that the pressure drops in the producing zones are around 0.1 atm (10.1325 kPa). In the section of the valve ports, the pressure drop increases to about 0.2 atm (20.265 kPa), with a gradual increase along the string, reaching 0.2 atm (20.265 kPa) in the lower zone and 0.4 atm (40.53 kPa) in the upper zone. In turn, in the PACI 2+1 completion, a significant pressure drop is noticeable in the upper zone, resulting both from the production in this zone and from the fact that the multi-position ICV is fed by a 7⅝″ (19.3675 cm) SSD. The pressure drop in the upper zone is approximately 4 atm (405.3 kPa), while the pressure drop from the lower production zone to the inlet of the multi-position ICV string is equivalent to 0.5 atm (50.6625 kPa).

Step 3 employs results from coupled 4-way CFD-DEM simulations to estimate the deposition rate. To this end, the turbulent flow of the continuous fluid phase with the dispersed solid particles is simulated, including the effect of the adhesion force.

Equations (3) and (4) represent momentum and mass balance equations for the continuous phase, where α [-] is the volume fraction of the phase, v [m/s] is the velocity vector, p [Pa] is the pressure, μ_{eff} [kg/m·s] the effective viscosity, g the acceleration of gravity vector, and f_{p-f} [N/m³] the coupling source term for computing the solid-fluid interactions. The subscript “f” denotes the fluid phase, while “s” denotes the particles. The effective viscosity is computed using the realizable k-ξ turbulence model. Equation (5) represents the momentum balance computed for each particle in the system, denoted by the index j. The force summation F_{P-P} [N] represents contact forces such as collision, adhesion, and friction. The summation F_{f-p} [N] represents the fluid-particle interaction forces such as drag, virtual mass, lift, and turbulent dispersion. The force F_{b} [N] represents volume-level interactions such as weight and buoyancy. Equation (6) is used to compute the position of each particle.

$$\text{?} [ \frac{\text{?}}{\text{?}} + \text{?} ] = - \text{?} + \text{?} \qquad ( 3 )$$

$$\frac{\partial ( \text{?} )}{ⅆ \text{?}} + ∇ \cdot ( \text{?} \text{?} ) = 0 \qquad ( 4 )$$

$$\text{?} \frac{\text{?}}{\text{?}} = {\sum }_{\text{?}}^{\text{?}} \text{?} + {\sum \text{?}}_{\text{?}}^{\text{?}} \qquad ( 5 )$$

$$\text{?} = \frac{{dx}_{\text{?}}}{dt} \qquad ( 6 )$$

$$\text{?} \text{indicates text missing or illegible when filed}$$

Based on the fluid dynamics simulations, the results of the PACI 3Z and PACI 2+1 configurations were compared to evaluate the impact of the differences in equipment architecture on the thermodynamic properties of the calcium carbonate. Equation (7) defines the supersaturation index that calculates the deviation of the system from the equilibrium condition, where “a” is the concentration of each compound and K_{eq} [-] is the equilibrium constant.

$$SS = \frac{\text{?} + \text{?}}{\text{?}} \qquad ( 7 )$$

$$\text{?} \text{indicates text missing or illegible when filed}$$

Table 2 presents the thermodynamic potential values at the outlets of the lower, intermediate, and upper zones for both configurations. It was observed that the PACI 2+1 configuration presented the highest thermodynamic formation potentials most of the time, exceeding PACI 3Z. This difference is attributed to the pressure variations, with a difference of −5.96%, −4%, and 0.25% between the two configurations. In PACI 2+1, the SSD valves were responsible for a large part of the pressure drop in each zone (81.12%, 72.59%, and 36.48%, respectively), while the ICVs in PACI 3Z contributed less than 40% of the total pressure drop, with a more uniform distribution along the pipelines. The calculated thermodynamic potentials showed a difference from the Multiscale® software of at most 8.2%, indicating that the models used are adequate for the simulated conditions.

TABLE 2
Thermodynamic production potential and difference from the
reference software along the production zones for the 2
completions studied for PACI2 + 1 and PACI3Z completions.

| | |
|---|---|
| PACI2 + 1 | PACI3Z |

| | Inlet | Outlet | Inlet | Outlet |
|---|---|---|---|---|
| Zone | [kg/day] | [kg/day] | [kg/day] | [kg/day] |
| Lower | 26.70 | 37.67 | 17.57 | 24.77 |
| Intermediate | 34.81 | 48.05 | 26.66 | 41.32 |
| Upper | 61.12 | 77.19 | 36.95 | 78.93 |

| | | |
|---|---|---|
| Multiscale | 6.7% | 7% |

From the thermodynamic calculations, it becomes possible to simulate the kinetic dynamics of the particles by using the population balance technique, which considers the system segregated into two particle populations computed from the deposition rate calculated in Step 3. Equations (8) to (10) represent the particle precipitation phenomenon and Equations (11) to (13) represent the scale.

$$\frac{{dN}_{1}}{dt} = \frac{- {N}_{1}}{2 {w}_{1}} G ( {L}_{1} ) + {B}_{\text{?}} - {A}_{\text{?}} - {kN}_{\text{?}}^{\text{?}} + \frac{{Q}_{\text{?}} {N}_{\text{?}} - {Q}_{\text{?}} ( 1 - ret ) {N}_{\text{?}}}{V} \qquad ( 8 )$$

$$\frac{{dN}_{\text{?}}}{dt} = \frac{- {N}_{\text{?}}}{2 {w}_{\text{?}}} G ( {L}_{\text{?}} ) + \frac{{N}_{\text{?}}}{2 {w}_{\text{?}}} G ( {L}_{\text{?}} ) + {A}_{\text{?}} - {A}_{\text{?}} - kN \text{?} + \frac{{Q}_{\text{?}} {N}_{\text{?}} - {Q}_{\text{?}} ( 1 - ret ) {N}_{\text{?}}}{V} \qquad ( 9 )$$

$$\frac{{dN}_{\text{?}}}{dt} = \frac{{N}_{\text{?}}}{2 {w}_{\text{?}}} G ( {L}_{\text{?}} ) + {A}_{\text{?}} - {kN}_{\text{?}}^{\text{?}} + \frac{{Q}_{\text{?}} {N}_{\text{?}} - {Q}_{\text{?}} ( 1 - ret ) {N}_{\text{?}}}{V} \qquad ( 10 )$$

$$\frac{{dN}_{\text{?}}}{dt} = \frac{- {N}_{\text{?}}}{2 {w}_{\text{?}}} {G}_{\text{?}} ( {L}_{\text{?}} ) + {B}_{\text{?}} - {A}_{\text{?}} - {k}_{\text{?}} {N}_{\text{?}}^{\text{?}} + \frac{{Q}_{\text{?}} \cdot ret \cdot {N}_{\text{?}}}{\text{?}} \qquad ( 11 )$$

$$\frac{{dN}_{\text{?}}}{dt} = \frac{- {N}_{\text{?}}}{2 {w}_{\text{?}}} {G}_{\text{?}} ( {L}_{\text{?}} ) + \frac{{N}_{\text{?}}}{2 {w}_{\text{?}}} {G}_{\text{?}} ( {L}_{\text{?}} ) + {A}_{\text{?}} - {A}_{\text{?}} - {k}_{\text{?}} {N}_{\text{?}}^{\text{?}} + \frac{{Q}_{\text{?}} ( ret ) {N}_{\text{?}}}{V} \qquad ( 12 )$$

$$\frac{{dN}_{\text{?}}}{dt} = \frac{{N}_{\text{?}}}{2 {w}_{\text{?}}} {G}_{\text{?}} ( {L}_{\text{?}} ) + {A}_{\text{?}} - {k}_{\text{?}} {N}_{\text{?}}^{\text{?}} + \frac{{Q}_{\text{?}} ( ret ) {N}_{\text{?}}}{V} \qquad ( 13 )$$

$$\text{?} \text{indicates text missing or illegible when filed}$$

Where Ni is the number of particles precipitated per m³ with size within the class, 1 for the first, i for the intermediate classes and n. for the largest size class; w is the size difference between the class limits; L is the upper limit of the class; G is the crystal growth term; A_{B} and A_{D} are the terms of appearance and disappearance of the crystals of the class; K is the kinetic constant of the polymorphic transformation; ro is the order of the reaction rate; Qₑₙₜ and Q_{saida} are the volumetric flow rates at the inlet and outlet of the control volume; Nᵢₑₙₜ and N_{isaida} are the number of particles with size i that enter and leave the region of the control volume and, finally, ret is the percentage of the particles that become scaled in the control volume. Table 3 lists the model parameters for calcium carbonate.

TABLE 3
Kinetic model parameters for the calcium carbonate formation.

| | Estimated | |
|---|---|---|
| Parameter | Value | Representation |
| knvat [1/m³ kg s] | 3.88 × 10⁴ | Vaterite nucleation |
| | | constant |
| nvat | 2.75 | Nucleation with SS ratio |
| | | for the vaterite |
| kgvat [m/s] | 1.506 × 10⁻⁸ | Vaterite growth constant |
| gvat | 1.69 | Growth with SS ratio for |
| | | the vaterite |
| n1vat | 0.499 | Crystal mass ratio to the |
| | | secondary nucleation |
| kgcalc [m/s] | 1.368 × 10⁻⁷ | Calcite growth constant |
| gcalc | 1.27 | Growth with SS ratio for |
| | | the calcite |
| kdvat [m/s] | 4.09 × 10⁻⁸ | Vaterite dissolution |
| | | constant |
| kdcalc [m/s] | 7.344 × 10⁻⁷ | Calcite dissolution |
| | | constant |
| kavat [s/m⁷] | 3.34 × 10³ | Vaterite agglomeration |
| | | constant |
| kacalc [s/m⁷] | 2.56 × 10³ | |
| k [1/s] | 1.05 × 10⁻⁸ | Polymorphic |
| | | transformation constant |
| ro | 1.5 | Order of polymorphic |
| | | transformation |
| knvat, inc [1/m⁵ s] | 5.15 × 10⁵ | Vaterite nucleation |
| | | constant on the metallic |
| | | surface |
| nvat, inc | 3.69 | Metallic nucleation with |
| | | SS ratio for the vaterite |
| p0 | 1.125 | Linear coefficient of the |
| | | polynomial for the effect |
| | | of the velocity |
| p1 | 52.83 | First-degree coefficient |
| | | of the polynomial for the |
| | | effect of the velocity |
| p2 | 5.51 | Second-degree coefficient |
| | | of the polynomial for the |
| | | effect of the velocity |

After the distance to thermodynamic equilibrium was calculated, kinetic simulations were performed, generating Table 4, which presents the scale production per zone in kg/day, calculated from the concentration resulting from the population balance. The crystalline production reflects the combination of the precipitation and scale phenomena, driven by the thermodynamic potential shown in Table 4. It is important to highlight that the production in the lower zone serves as a source for the increased production in the subsequent zones throughout the process. As the crystal population grows throughout the completion, the progressive deposition of crystalline mass occurs, calculated based on the CFD-DEM results. In addition, there is particle nucleation directly on the metal surface or on already scaled particles, a process intensified by supersaturation and increased velocity throughout completion. Consequently, there is an increase in scaled mass in the production zones due to the continuous favoring of nucleation rates at the particle-metal interface. Table 4 presents the masses of scales in the region of interest, along with the percentage resulting from the deposition of solids generated within the liquid. The remaining mass is a result of nucleation on the surface of the equipment, crystal growth, and deposition on already scaled solids.

TABLE 4
Kinetic production of crystalline scale and the contribution
of the deposition along the production zones in the completions
studied for the PACI2 + 1 and PACI3Z completions.

| | |
|---|---|
| PACI2 + 1 | PACI3Z |

| | Inlet | Outlet | Inlet | Outlet |
|---|---|---|---|---|
| Zone | [g/day] | [g/day] | [g/day] | [g/day] |
| Lower | 3.25 | 1.58 | 2.78 | 1.08 |
| Intermediate | 6.55 | 4.17 | 4.60 | 2.89 |
| Upper | 137.68 | 113.04 | 21.17 | 118.57 |
| Deposition | 0.06% | 5.28% | 0.08% | 1.1% |

The introduction of particle scale resulted in a significant increase in daily production compared to results based solely on precipitation in the liquid. This increase is due to the longer residence time of the particles, which act as more durable nucleation points. The kinetic analysis confirms that the metal-particle nucleation is more efficient than the particle-particle nucleation until more than 70% of the metal area is filled, at which point the particle-particle nucleation becomes more surpasses the former. The solid deposition in the liquid was less significant, confirming that the direct nucleation on the metal surface is the main cause of scale formation, as indicated in the literature. The results of the thermodynamic and kinetic simulations disclose substantial differences compared to models without precipitation, reflecting updated operational information from the completion Tallys.

In the PACI2+1 and PACI3Z completions, the differences in mass production varied by region, with PACI2+1 showing lower productions in the lower region and higher productions in the intermediate region, and PACI3Z showing higher production in the upper region due to higher velocities and thermodynamic potentials. The analysis of the production percentages in Tables 2 and 4 highlights that in the port region the scale model is predominant due to the high surface area and low residence times, while in the strings, where residence times are longer, the precipitation has a greater contribution. PACI 2+1, with longer residence times and a larger area in the string, showed the highest particle deposition, followed by PACI3Z. The results emphasize the importance of the interaction between residence times and surface areas in the precipitation and scale processes, corroborating previous findings on the influence of the residence times on formation of scales.

With the calculated thermodynamic potentials and kinetic productions, it is possible to determine the scale potential index for each zone of the PACI 2+1 and PACI 3Z completions, presented in Table 5.

$${Index}_{( k )} = \frac{0.002}{{m}_{kineticoutlet ( k )} - {m}_{kineticinlet ( k )}} \qquad ( 14 )$$

where \dot{m}_{kineticinlet(k)} is the mass flow rate of calcium carbonate at the inlet of the completion equipment and \dot{m}_{kineticoutlet(k)} é is the mass flow rate of calcium carbonate at the outlet of the completion equipment.

The analysis discloses that the PACI 2+1 completion is the most critical, especially in the upper zones, where scale production reaches 137 g/day, in contrast to only 21 g/day in PACI 3Z. This significant increase is associated with the higher thermodynamic potentials of PACI 2+1, resulting from the presence of a 7⅝″ (19.3675 cm) SSV valve, which intensifies the pressure drop. The improved modeling of surface areas and pressure drops, based on updated Tallys data, contributed to a more precise view of the operating conditions, directly reflecting the discrepancies observed in the pressure drops, residence times, and scale rates.

TABLE 5
Scale indices along the production
zones in PACI2 + 1 and PACI3Z.

| Zone | PACI 2 + 1 | PACI 3Z |
|---|---|---|
| Lower | 0.413 | 0.516 |
| Intermediate | 0.186 | 0.266 |
| Upper | 0.007 | 0.014 |
| Overall | 0.204 | 0.265 |

The comparison between the two configurations highlights the relevance of a detailed and precise analysis to understand the nuances between the completions. PACI 2+1, with its operational characteristics that favor both scale and precipitation, demonstrates greater criticality due to the prolonged residence times and larger surface areas, which promote the formation of scales and precipitation. On the other hand, PACI 3Z, although less critical, still presents significant challenges, especially in the upper zones. The analysis reinforces the importance of a tool that allows for the evaluation and comparison of operational conditions and the risks associated with different completion configurations, providing a solid basis for informed decision-making and the optimization of scale management processes.

### BIBLIOGRAPHIC REFERENCES

Neubauer (2022). “Crystallization of calcium carbonate: Modelling thermodynamic equilibrium, pathway, nucleation, growth, agglomeration, and dissolution kinetics for the calcium carbonate polymorphs formation”.
EROINI (2013), V.; NEVILLE, A.; KAPUR, N.; EUVRARD, M. “New insight into the relation between bulk precipitation and surface deposition of calcium carbonate mineral scale. Desalination and Water Treatment”, v. 51, n. 4-6, p. 882-891, 2013.

What is claimed is:

1. A method for integrating fluid dynamic, thermodynamic, and kinetic models of calcium carbonate scale in a well completion, the method comprising:
a) collection of geometric, operational, and chemical composition data of completion and of production fluids;
b) generation of velocity and pressure magnitude profiles along the completion, using computational fluid dynamics (CFD) techniques;
c) calculation of a solid crystal deposition rate in completion equipment, considering segregation of suspended and scaled crystal populations, based on a population balance model (PBM);
d) performance of thermodynamic and kinetic simulations, integrating results of previous steps to predict nucleation, growth and deposition processes of crystals under specific conditions of chemical equilibrium and flow dynamics; and
e) calculation of a scale index for each piece of equipment and for the completion as a whole, allowing quantitative and comparative analysis of a scale risk.

2. The method according to claim 1, wherein collection of the data includes information on a type of completion, a flow rate of liquid and gaseous phases, a chemical composition of the fluids, a temperature, a pressure and specific geometries of the completion equipment.

3. The method according to claim 1, wherein step b) comprises use of dimensionless velocity and pressure profiles obtained from a previously simulated database, which are adjusted for specific flow rate and geometry conditions of each production zone.

4. The method according to claim 1, further comprising calculation of a solid crystal deposition rate, using fluid property data, granulometric distribution, polymorph distribution and dispersed solids concentrations obtained from the kinetic simulation in step d).

5. The method according to claim 1, wherein the kinetic model includes a population balance segregated into two populations: particles suspended in liquid and particles scaled on equipment surfaces.

6. The method according to claim 1, wherein the scale index is calculated based on a difference between a mass of solid crystals at an inlet and outlet of each piece of equipment, with an overall completion index obtained by a weighted average of the mass concentrations.

7. The method according to claim 1, further comprising evaluating and comparing different completion configurations, considering individual and overall scale indices for each architecture and production scenario.

8. The method according to claim 1, further comprising using thermodynamic simulations that consider three-phase chemical equilibrium conditions to predict supersaturation and stability of calcium carbonate polymorphs under different operating conditions.

9. The method according to claim 1, further comprising using a particle dynamics model (CFD-DEM) to simulate transport, agglomeration, and deposition of solid particles, considering adhesion forces and turbulent flow.

10. The method according to claim 1, wherein the scale index (Index₍ₖ₎) is given by:
$${Index}_{( k )} = \frac{0.002}{{m}_{kineticoutlet ( k )} - {m}_{kineticinlet ( k )}}$$
where, \dot{m}_{kineticinlet(k)} is mass flow rate of calcium carbonate at an inlet of the completion equipment and \dot{m}_{kineticoutlet(k)} é is mass flow rate of calcium carbonate at an outlet of the completion equipment.
